(19) United States
(12) Patent Application Publication
(10) Pub. No.: US 2022/0376246 A1
(43) Pub. Date: Nov. 24, 2022

(54) LAMELLAR IRON SULFIDES WITH EMBEDDED CATIONS FOR ELECTRICAL ENERGY STORAGE

(71) Applicant: The University of Chicago, Chicago, IL (US)

(72) Inventors: John S. Anderson, Chicago, IL (US); Noah E. Horwitz, Chicago, IL (US); Jiaze Xie, Chicago, IL (US)

(21) Appl. No.: 17/765,176

(22) PCT Filed: Sep. 29, 2020
(86) PCT No.: PCT/US2020/053252

§ 371 Date: Mar. 30, 2022

Related U.S. Application Data
(60) Provisional application No. 62/907,979, filed on Sep. 30, 2019.

(51) Int. Cl. H01M 4/58; H01G 9/042; H01M 4/36; H01M 4/66; H01M 4/62; H01M 4/136; H01M 10/0525

(52) U.S. Cl. CPC H01M 4/58; H01G 9/042; H01M 4/366; H01M 4/663; H01M 4/623; H01M 4/622; H01M 4/136; H01M 10/0525

(57) ABSTRACT

A lamellar transition metal sulfide composition having layers of an amorphous transition metal sulfide with cations interspersed between the layers is described. Also described are methods of synthesizing the lamellar transition metal sulfides and the use of the lamellar transition metal sulfides in electrodes, e.g., in metal-ion batteries, metal-ion/sulfur batteries, and capacitors.

### RELATED APPLICATIONS

The presently disclosed subject matter claims the benefit of U.S. Provisional Patent Application Ser. No. 62/907,979 filed Sep. 30, 2019, the disclosure of which is incorporated herein by reference in its entirety.

### STATEMENT OF GOVERNMENT SUPPORT

This invention was made with government support under grant number DESC0019215 awarded by the U.S. Department of Energy. The government has certain rights in the invention.

### TECHNICAL FIELD

The presently disclosed subject matter relates to lamellar transition metal sulfides, such as lamellar iron sulfides, comprising layers of transition metal sulfides with cations (e.g., solvated cations or organic cations) between the layers. The presently disclosed subject matter further relates to methods of synthesizing the lamellar transition metal sulfides and to the use of the lamellar transition metal sulfides in electrodes, e.g., for metal-ion batteries, metal-ion/sulfur batteries, and capacitors.

### Abbreviations

° C.=degrees Celsius
% percentage
Å=angstrom
Ca=calcium
cm=centimeter
CV=cyclic voltammetry
deg=degree
DEDTC=diethyl dithio carbamate
DMF=dimethyl formamide
eV=electronvolt
EX=ethyl xanthate
EXAFS=extended X-ray absorption fine structure
F=farad
Fe=iron
g=gram
h=hours
K=potassium
Li=lithium
LIB=lithium ion battery
mA=milliampere
Mg=magnesium
mV=millivolt
Na=sodium
nm=nanometers
OTf=triflate
Ph=phenyl
S=sulfur
S/cm=Siemens per centimeter
TBA=tetrabutyl ammonium
TCNE=tetracyanoethylene
TCNQ=tetracyanoquinodimethane
THF=tetrahydrofuran
TMA=tetramethyl ammonium
UV=ultraviolet
V=volt
XAS=X-ray absorption spectrometry
XRPD=X-ray powder diffraction

### BACKGROUND

There is an enormous projected need for inexpensive and long-lived energy storage devices over the coming decades.¹ This energy storage will be employed in many different capacities, such as aiding in the utilization of intermittent renewable energy sources, improving the reliability of electricity in grid-scale deployment, as well as in mobile forms such as electric vehicles.² The broad application and scale of batteries therefore provides incentive into developing new and improved technology.³

The existing state-of-the-art technology for batteries involves lithium ion batteries (LIBs).⁴ The three main materials which can be modified to improve performance of batteries are the anode, the cathode, and the solvent/electrolyte. The anode and the cathode are the materials that actually undergo redox changes under charge/discharge cycling.⁵ Graphite and related carbon-based anodes have emerged as inexpensive and relatively robust anode materials, although titanate and silicon based electrodes have also attracted attention.⁶ Cathode materials are typically based on cobalt oxide with various other metal dopants such as Mn, Ni, and Al, although iron phosphate cathodes are also employed in some applications.^{7,8}

These materials, particularly the cathode materials, represent a significant fraction of the cost of battery cells and thus represent an important target for new materials science.⁹ However, while there has been significant interest in modifying these materials to lower cost and increase performance,⁷ virtually all large-scale battery production is still limited to the materials mentioned above.

Accordingly, there is an ongoing need to provide new materials suitable for cathode applications, particularly for less expensive materials prepared from more abundant sources. There is also a need for materials that can provide improved storage density and service lifetimes.

### SUMMARY

In some embodiments, the presently disclosed subject matter provides a lamellar transition metal sulfide composition comprising layers of an amorphous transition metal sulfide and further comprising cations between layers of the amorphous transition metal sulfide. In some embodiments, the cation is a solvated cation.

In some embodiments, the transition metal sulfide comprises one or more transition metal selected from the group comprising scandium (Sc), titanium (Ti), vanadium (V), chromium (Cr), manganese (Mn), iron (Fe), cobalt (Co), nickel (Ni), copper (Cu), and zinc (Zn). In some embodiments, the transition metal sulfide is an iron sulfide. In some embodiments, the ratio of iron (Fe) to sulfur (S) in the iron sulfide is about 0.75 to 1.

In some embodiments, the cations comprise monocations, dications, or combinations thereof. In some embodiments, the cations are alkali metal cations, alkaline earth metal cations, or organic cations. In some embodiments, the cations comprise one or more cations selected from Li⁺, Na⁺, K⁺, Mg²⁺, Ca²⁺, and tetraalkylammonium cations.

In some embodiments, the cations are solvated by a polar aprotic solvent. In some embodiments, the polar aprotic solvent comprises a carbonate solvent, an ether solvent, dimethyl formamide (DMF), or acetonitrile. In some embodiments, the cation and/or a solvent for solvation of the cation is selected to obtain a desired interlayer spacing between consecutive layers.

In some embodiments, the presently disclosed subject matter provides a method of preparing a lamellar transition metal sulfide composition comprising layers of an amorphous transition metal sulfide and further comprising cations between layers of the amorphous transition metal sulfide, wherein the method comprises contacting a transition metal complex selected from the group consisting of a bis- or tris(dialkyldithiocarbamato)transition metal complex and a bis- or tris(alkylxanthato)transition metal complex with a polar aprotic solvent for a period of time in the presence of an alkali metal salt, an alkaline earth metal salt, or an organic salt. In some embodiments, the cations between layers of the amorphous transition metal sulfide are solvated cations.

In some embodiments, the contacting is performed at a temperature of at least about 25° C. In some embodiments, the contacting is performed at a temperature of between about 25° C. and about 140° C.

In some embodiments, the transition metal complex is selected from tris(diethyldithiocarbamato)iron(III) (Fe(DEDTC)₃) and tris(ethylxanthato)iron(III) (Fe(EX)₃). In some embodiments, the alkali metal salt, the alkaline earth metal salt, or the organic salt comprises a lithium, sodium, potassium, magnesium, calcium, or tetraalkylammonium salt and/or wherein the salt comprises an anion selected from a triflate, a chloride, and a hexafluorophosphate. In some embodiments, the polar aprotic solvent comprises a carbonate, an ether, DMF, or acetonitrile. In some embodiments, the polar aprotic solvent is selected from the group consisting of DMF and tetrahydrofuran (THF).

In some embodiments, the contacting is performed in the presence of a soluble sulfide source. In some embodiments, the soluble sulfide source comprises an alkali metal sulfide, S₈, a thiourea, or 1,2,4,5-tetrazinane-3,6-dithione.

In some embodiments, interlayer spacing between consecutive layers of the lamellar transition metal sulfide is tuned based on selection of the salt and/or solvent. In some embodiments, the presently disclosed subject matter provides a lamellar transition metal sulfide prepared by contacting a transition metal complex selected from the group consisting of a bis- or tris(dialkyldithiocarbamato)transition metal complex and a bis- or tris(alkylxanthato)transition metal complex with a polar aprotic solvent for a period of time in the presence of an alkali metal salt, an alkaline earth metal salt, or an organic salt

In some embodiments, the presently disclosed subject matter provides a method of preparing a lamellar transition metal sulfide composition comprising layers of an amorphous transition metal sulfide and further comprising cations between layers of the amorphous transition metal sulfide, wherein the method comprises contacting a synthetic transition metal-sulfide cluster with an oxidizing agent in the presence of a polar aprotic solvent and an alkali metal salt, an alkaline earth metal salt, or an organic salt. In some embodiments, the cations between layers of the amorphous transition metal sulfide are solvated cations.

In some embodiments, the synthetic transition metal-sulfide cluster is a 4Fe-4S cluster. In some embodiments, the 4Fe-4S cluster is [Fe₄S₄(SC₆H₅)₄](C₁₆H₃₆N)₂. In some embodiments, the oxidizing agent is selected from the group comprising tetracyanoethylene (TCNE), iodine, ferrocenium tetrafluoroborate (FeCp₂BF₄), tetracyanoquinodimethane (TCNQ), and lithium chloroanilate (Li₂C₆Cl₂O₄).

In some embodiments, the polar aprotic solvent is DMF and/or the contacting is performed at a temperature between about 25° C. and about 140° C. In some embodiments, interlayer spacing between consecutive layers is tuned based on selection of the salt and/or solvent. In some embodiments, the presently disclosed subject matter provides a lamellar transition metal sulfide composition prepared by contacting a synthetic transition metal-sulfide cluster with an oxidizing agent in the presence of a polar aprotic solvent and an alkali metal salt, an alkaline earth metal salt, or an organic salt.

In some embodiments, the presently disclosed subject matter provides a composite comprising (i) a conductive substrate and (ii) a polymeric binder combined with a lamellar transition metal sulfide composition further comprising cations between layers of the amorphous transition metal sulfide. In some embodiments, the conductive substrate is carbon fiber paper or carbon black. In some embodiments, the polymeric binder is poly(vinylidene fluoride) (PVDF), natural rubber, or synthetic rubber.

In some embodiments, the presently disclosed subject matter provides an electrode comprising a lamellar transition metal sulfide composition, wherein the lamellar transition metal sulfide composition further comprises cations between layers of the amorphous transition metal sulfide, or a composite of said lamellar transition metal sulfide composition. In some embodiments, the presently disclosed subject matter provides a metal-ion battery comprising said electrode.

In some embodiments, the battery is a lithium-, sodium-, or magnesium-ion battery. In some embodiments, the battery is a lithium-ion battery and the electrode has a discharge capacity of at least about 450 mAh/g or more for at least a first 17 cycles. In some embodiments, said electrode exhibits a cycling stability of at least 90% for at least 17 cycles when cycled between 1.0 volts (V) and 3.0 V.

In some embodiments, the presently disclosed subject matter provides a capacitor comprising an electrode comprising a lamellar transition metal sulfide composition, wherein the lamellar transition metal sulfide composition further comprises cations between layers of the amorphous transition metal sulfide, or a composite of said lamellar transition metal sulfide composition. In some embodiments, the electrode has a specific capacitance of about 100 F/g.

In some embodiments, the presently disclosed subject matter provides a metal-ion/sulfur battery comprising an electrode comprising a lamellar transition metal sulfide composition, wherein the lamellar transition metal sulfide composition further comprises cations between layers of the amorphous transition metal sulfide, or a composite of said lamellar transition metal sulfide composition. In some embodiments, the metal is lithium, sodium, or magnesium.

Accordingly, it is an object of the presently disclosed subject matter to provide lamellar transition metal sulfide compositions that comprise interlayer cations, methods of synthesizing such compositions, and composites, electrodes, batteries, and capacitors comprising such compositions.

An object of the presently disclosed subject matter having been stated hereinabove, and which is achieved in whole or in part by the presently disclosed subject matter, other objects will become evident as the description proceeds hereinbelow.

### BRIEF DESCRIPTION OF THE DRAWINGS

FIG. 1 is a schematic diagram showing the chemical structure of an exemplary lamellar transition metal sulfide, lamellar iron sulfide, of the presently disclosed subject matter highlighting areas of tunability.

FIG. 2 is a schematic diagram showing synthetic routes to an exemplary lamellar transition metal sulfide, lamellar iron sulfide, of the presently disclosed subject matter.

FIG. 3A is a graph showing XRPD spectra of a wet (solid line) and dry (dashed line) lamellar iron sulfide prepared by solvothermal decomposition of Fe(DEDTC)₃ in the presence of LiOTf (LiCF₃SO₃).

FIG. 3B is a graph showing a XRPD spectrum of a wet lamellar iron sulfide prepared by solvothermal decomposition of Fe(EX)₃ in the presence of LiOTf (LiCF₃SO₃).

FIG. 3C is a graph showing XRPD spectra of a wet (solid line), dry (dotted line) and rewet (dotted and dashed line) lamellar iron sulfide prepared by the oxidation of a Fe₄S₄ cluster with TCNE in DMF.

FIG. 3D is a graph showing XRPD spectra of wet (solid and dotted lines) and dry (dotted and dashed line and dashed line) lamellar iron sulfides prepared by the oxidation of a Fe₄S₄ cluster with TCNE in DMF (solid line and dotted and dashed line) or THF (dotted line and dashed line).

FIG. 4A is a graph showing XRPD spectra of lamellar iron sulfides prepared in the presence of no salt (solid line), 5 equivalents of LiOTf (dotted line), 40 equivalents of LiOTf (dotted and dashed line), or 5 equivalents of LiCl (dashed line).

FIG. 4B is a graph showing XRPD spectra of lamellar iron sulfides prepared in the presence of no salt (solid line) or in the presence of five equivalents of: LiOTf (dotted line), NaOTf (dotted and dashed line), KOTf (dashed line) or TMAPF₆ (dotted line with smaller dots).

FIG. 4C is a graph showing XRPD spectra of the lamellar iron sulfides prepared in the presence of the salts described for FIG. 4B with the spectra offset.

FIG. 5A is a graph showing a calculated XRPD spectrum of a naturally occurring iron sulfide (i.e., Smythite) with ordered lamellae.

FIG. 5B is a graph showing a XRPD spectrum of a lamellar iron sulfide of the presently disclosed subject matter prepared by solvothermal decomposition of Fe(DEDTC)₃ in the presence of LiOTf.

FIG. 6 is a graph showing the XANES regions of the XAS spectra of a synthetic lamellar iron sulfide of the presently disclosed subject matter. The edge position of the synthetic lamellar iron sulfide is consistent with Fe²⁺. The circle in the graph shows that the pre-edge is consistent with tetrahedral coordination at Fe.

FIG. 7A is a graph showing the EXAFS region of XAS data of a synthetic lamellar Fe_{0.75}SLi_{0.1} sample fit to data for a Mackinawite model.

FIG. 7B is a schematic diagram showing a proposed structural model for the synthetic lamellar iron sulfide described in FIG. 7A.

FIG. 8 is a graph showing the plot of the Tauc direct band gap of a lamellar iron sulfide of the presently disclosed subject matter.

FIG. 9 is a graph showing the 80 K Mössbauer spectrum of a lamellar iron sulfide of the presently disclosed subject matter with fit and parameters shown.

FIG. 10A is a graph showing the CV (dotted and dashed line) of an electrode comprising a lamellar iron sulfide of the presently disclosed subject matter on a carbon paper substrate, showing a capacitive feature. The electrode was prepared by sonicating the iron sulfide with rubber cement (10% dry mass) in THF and dip coating a 1 cm² carbon paper in the resulting slurry. For comparison, the CV of blank carbon paper (solid line) and of rubber cement on the carbon paper (dotted line) are also shown.

FIG. 10B is a graph showing the specific capacitance of a lamellar iron sulfide of the presently disclosed subject matter as a function of scan rate.

FIG. 11A is a graph showing possible Faradaic features of the electrode described for FIG. 10A.

FIG. 11B is a graph showing the effect of varying electrolyte on the electrochemistry of the electrode described for FIG. 10A.

FIG. 12A is a graph showing the voltage profile of a lithium cell comprising an electrode comprising a lamellar iron sulfide of the presently disclosed subject matter.

FIG. 12B is a graph showing the dQ/dV plots of a lithium cell comprising an electrode comprising a lamellar iron sulfide of the presently disclosed subject matter.

FIG. 12C is a graph showing the cycle performance of a lithium cell comprising an electrode comprising a lamellar iron sulfide of the presently disclosed subject matter.

FIG. 13A is a graph showing the voltage profile of a sodium cell comprising an electrode comprising a lamellar iron sulfide of the presently disclosed subject matter.

FIG. 13B is a graph showing the dQ/dV plots of a sodium cell comprising an electrode comprising a lamellar iron sulfide of the presently disclosed subject matter.

FIG. 13C is a graph showing the cycle performance of a sodium cell comprising an electrode comprising a lamellar iron sulfide of the presently disclosed subject matter.

FIG. 14 is a schematic diagram of ball-and-stick figures showing different morphologies of proposed lamellar iron sulfides (right) and their corresponding closest minerals and compositions (left).

FIG. 15A is a schematic diagram showing the charged (right) and discharged (left) states of a cathode comprising a lamellar iron sulfide of the presently disclosed subject matter without additional sulfide ion.

FIG. 15B is a schematic diagram showing the charged (right) and discharged (left) states of a cathode comprising a lamellar iron sulfide of the presently disclosed subject matter with additional sulfide ion.

FIG. 16 is a schematic diagram showing the potential formation of interlayer polysulfides in the presently disclosed lamellar iron sulfides upon oxidative loading.

### DETAILED DESCRIPTION

The presently disclosed subject matter will now be described more fully. The presently disclosed subject matter can, however, be embodied in different forms and should not be construed as limited to the embodiments set forth herein below and in the accompanying Examples. Rather, these embodiments are provided so that this disclosure will be thorough and complete, and will fully convey the scope of the embodiments to those skilled in the art.

All references listed herein, including but not limited to all patents, patent applications and publications thereof, and scientific journal articles, are incorporated herein by reference in their entireties to the extent that they supplement, explain, provide a background for, or teach methodology, techniques, and/or compositions employed herein.

Throughout the specification and claims, a given chemical formula or name shall encompass all optical and stereoisomers, as well as racemic mixtures where such isomers and mixtures exist.

### I. Definitions

While the following terms are believed to be well understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs.

Following long-standing patent law convention, the terms “a,” “an,” and “the” refer to “one or more” when used in this application, including the claims.

The term “and/or” when used in describing two or more items or conditions, refers to situations where all named items or conditions are present or applicable, or to situations wherein only one (or less than all) of the items or conditions is present or applicable.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” can mean at least a second or more.

The term “comprising,” which is synonymous with “including,” “containing,” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

Unless otherwise indicated, all numbers expressing quantities of size, temperature, time, weight, volume, concentration, capacitance, specific capacity, discharge capacity, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value is meant to encompass variations of in one example ±20% or ±10%, in another example ±5%, in another example ±1%, and in still another example ±0.1% from the specified amount, as such variations are appropriate to perform the disclosed methods.

Numerical ranges recited herein by endpoints include all numbers and fractions subsumed within that range (e.g. 1 to 5 includes, but is not limited to, 1, 1.5, 2, 2.75, 3, 3.90, 4, and 5).

### II. General Considerations

Transition metals feature prominently in cathode materials due to their facile redox chemistry which facilitates charging and discharging. In particular, Co has formed the basis of the most successful commercial cathodes, but the cost and abundance of Co are major drivers of the expense of cathode materials.⁹ Fe is the most abundant transition metal, and, therefore, could be useful in reducing cost. However, the charge density of materials such as LiFePO₄ has been a drawback to their use.⁸

Iron sulfides are a potentially attractive class of materials due to a higher potential charge density as well as favorable charge and ion transport properties imbued by sulfur (S). Indeed, pyrite-based electrodes were some of the earliest materials studied in LIBs and similar iron sulfide-based materials have attracted a great deal of recent attention.^{10,11} Despite this, significant challenges remain, notably cycling life, volume expansion, and charge density. One way to address these issues is the use of layered iron sulfides. A prime example of these materials is Li₂FeS₂, although other layered materials have also been reported more recently.^{10,12} The layered nature of these materials should enable better ion transport and facilitate volume changes more readily. Nevertheless, there have only been limited investigations into the applicability of layered sulfides as battery components.¹³ Furthermore, while Li₂FeS₂ is nominally layered, it is a close packed structure with potentially poor ion transport characteristics.

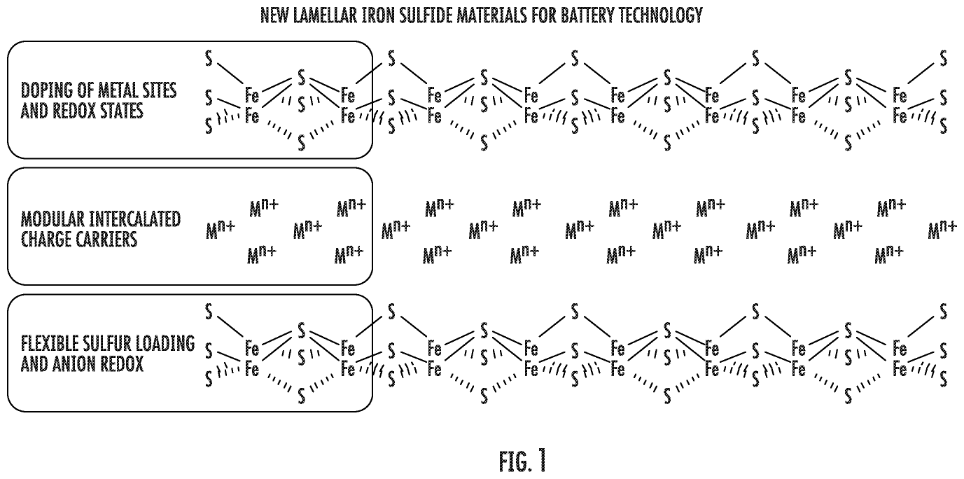

As described hereinbelow, the presently disclosed subject matter provides, in some embodiments, lamellar transition metal sulfide compositions (i.e., synthetic lamellar transition metal sulfide compositions) further comprising cations. The cations can be present between layers of the transition metal sulfide. In some embodiments, the cations are solvated. In some embodiments, the lamellar transition metal sulfide further comprises solvated metal cations (e.g., solvated alkali metal cations or solvated alkaline metal cations) or organic cations (e.g., tetraalkylammonium cations) between layers of the transition metal sulfide. The lamellar transition metal sulfide compositions can have tunable layer spacing and composition. In particular, the lamellar structure and flexible redox characteristics make these materials ideal candidates for anode or cathode applications. See FIG. 1, which shows an exemplary lamellar iron sulfide of the presently disclosed subject matter, and tunable features thereof, including the ability to dope metal sites and metal redox states in the transition metal sulfide layers, the ability the change the identity of the intercalated cationic charge carrier between the layers, and the ability to add additional sulfur. Accordingly, the materials represent new low-cost, high charge density, and/or long service life electrode materials and charge storage materials (e.g., capacitors).

In some embodiments, the presently disclosed transition metal sulfide materials have a lamellar structure comprising transition metal sulfide layers (e.g., amorphous transition metal sulfide layers) with cations positioned between the layers. The distance between consecutive layers can be varied depending upon factors such as the identity of the cation and/or the solvation of the cation. The ability to vary the spacing between layers can, for example, provide flexible lattice parameters that can facilitate the large volume changes associated with sulfur cathodes.

In some embodiments, the transition metal is a first-row transition metal or a combination thereof, i.e., scandium (Sc), titanium (Ti), vanadium (V), chromium (Cr), manganese (Mn), iron (Fe), cobalt (Co), nickel (Ni), copper (Cu), zinc (Zn), or a combination thereof. In some embodiments, the transition metal sulfide is an iron sulfide. In some embodiments, the transition metal sulfide can comprise metal centers of more than one oxidation state and/or more than one type of coordination geometry. In some embodiments, the stoichiometric ratio of transition metal to sulfur is less than 1. In some embodiments, the ratio of transition metal to sulfur can be adjusted to increase the sulfur content, e.g., by the inclusion of additional sulfide ions (such as by exposure of the transition metal sulfide to a solution of S²⁻ ions). In some embodiments, as further described hereinbelow, the inclusion of additional sulfide ions can add additional negative charge to the transition metal sulfide layers, which can, for example, increase the charge storage density of the layers.

In some embodiments, the transition metal sulfide can comprise iron sulfide comprising both Fe(II) and Fe(III). In some embodiments, the ratio of Fe(II) and Fe(III) can be varied to include relatively more Fe(III), for example, to provide higher charge storage density via reduction to Fe(II) during discharge from electrodes prepared from the materials. In some embodiments, the iron sulfide comprises both tetrahedral and octahedral coordination sites. In some embodiments, the iron sulfide has a stoichiometric ratio of iron (Fe) to sulfur (S) that is less than 1. In some embodiments, the ratio of Fe to S in the presently disclosed synthetic lamellar iron sulfides is between that for the naturally occurring iron sulfides Tochilinite or Mackinawite (i.e., about 1) and Greigite (i.e., about 0.75). In some embodiments, the ratio of Fe to S is about 0.75.

In some embodiments, the cations can include, but are not limited to, monocations or dications. In some embodiments, the monocations or dications are cations (e.g., solvated cations) of an alkali metal or an alkaline earth metal (e.g., lithium (Li), sodium (Na), potassium (K), rubidium (Rb), cesium (Cs), beryllium (Be), magnesium (Mg), calcium (Ca), strontium (Sr), or barium (Ba)). In some embodiments, the cations are selected from Li⁺, Na⁺. K⁺, Mg²⁺, and Ca²⁺. However, in some embodiments, the lamellar transition metal sulfides can also comprise or consist of organic cations (e.g., tetraalkylammonium cations, etc.) located between the layers. The inclusion of organic cations, for instance, can keep the layers of the lamellar transition metal sulfide separate under cycling conditions.

In some embodiments, the cations are solvated by a polar aprotic solvent. As used herein, the term “polar aprotic solvent” refers to a solvent having a high dielectric constant and high dipole movement and that lacks an acidic hydrogen. Suitable polar aprotic solvents include, but are not limited to, carbonate solvents, such as, but not limited to, cyclic and noncyclic alkyl carbonates (e.g., ethylene carbonate (EC), propylene carbonate (PC), dimethyl carbonate (DMC), and diethyl carbonate (DEC); alkyl esters (e.g., methyl formate, ethyl formate, methyl acetate, and ethyl acetate); ethers, including cyclic ethers (e.g., 1,3-dioxolane (DN), tetrahydrofuran (THF), 2-methyl tetrahydrofuran (Me-THF), and 2,5-dimethyl tetrahydrofuran) and noncyclic aliphatic ethers (e.g., diethyl ether and 1,2-dimethoxyether (DME)); lactones (e.g., valerolactone and γ-butyrolactone), dimethyl formamide (DMF), dimethylacetamide (DMAc), acetone, acetonitrile (MeCN), N-methyl-2-pyrrolidone (NMP), and dimethyl sulfoxide (DMSO). In some embodiments, the polar aprotic solvent is selected from a carbonate, an ether, DMF, and MeCN.

As indicated above, the particular cation or solvent can be selected to obtain a desired interlayer spacing between the layers of transition metal sulfide (i.e., the sheets of transition metal sulfide). For example, for a lamellar iron sulfide of the presently disclose subject matter, inclusion of solvated Li⁺ ions where the solvent is DMF can provide an interlayer spacing of about 16 angstroms (Å). Upon drying, the interlayer spacing of the same material is reduced to about 10 Å.

In some embodiments, the presently disclosed subject matter provides a method of preparing a lamellar transition metal sulfide composition comprising layers of a transition metal sulfide (e.g., an amorphous transition metal sulfide) and further comprising cations (e.g., solvated cations) between layers of the transition metal sulfide via solvothermal decomposition. In some embodiments, the method comprises contacting a transition metal complex with a polar aprotic solvent in the presence of salt. In some embodiments, the transition metal complex is a bis- or tris(dialkyldithiocarbamato)transition metal complex or a bis- or tris(alkylxanthato)transition metal complex. In some embodiments, the salt is an alkali metal salt or an alkaline earth metal salt. In some embodiments, the salt is an organic salt (e.g., a tetraalkylammonium salt). In some embodiments, an excess of salt is present compared to the transition metal complex. In some embodiments, 2, 3, 4, 5 or more molar equivalents of the salt are present compared to the transition metal complex.

The contacting can be performed at any suitable temperature. In some embodiments, the contacting is performed at a temperature between ambient temperature and the boiling point of the solvent or just below (e.g., about 5° C. or about 10° C. lower than the boiling point of the solvent). In some embodiments, the contacting is performed at a temperature of at least about 25° C. In some embodiments, the contacting is performed at a temperature of between about 25° C. and about 140° C. Typically, increasing the temperature can result in a faster conversion of the starting material to the product. In some embodiments, changing the temperature can alter the ordering or crystallinity of the resulting transition metal sulfide layers.

In some embodiments, the transition metal complex is a bis- or tris (diethyldithiocarbamato) metal complex or a bis- or tris(ethylxanthato) transition metal complex. In some embodiments, the transition metal complex is selected from tris(diethyldithiocarbamato)iron(III) (Fe(DEDTC)₃) and tris(ethylxanthato)iron(III) (Fe(EX)₃).

In some embodiments, the alkali metal salt or the alkaline earth metal salt comprises a lithium, sodium, potassium, magnesium, or calcium salt. In some embodiments, the organic salt comprises a tetraalkylammonium salt (e.g., a tetramethylammonium (TMA) salt or a tetraethylammonium salt). Suitable anions for the salts include, but are not limited to triflate (OTf), a halide (e.g., chloride), and hexafluorophosphate. In some embodiments, the polar aprotic solvent is a carbonate, an ether, DMF, or acetonitrile. In some embodiments, the polar aprotic solvent is selected from DMF and THF. As noted above, interlayer spacing between consecutive layers of the transition metal sulfide can be dependent upon the identity of the cation and/or solvent present. Thus, in some embodiments, the interlayer spacing is tuned based on selection of a particular alkali metal salt, alkaline earth salt, or organic salt and/or based on the selection of a particular solvent.

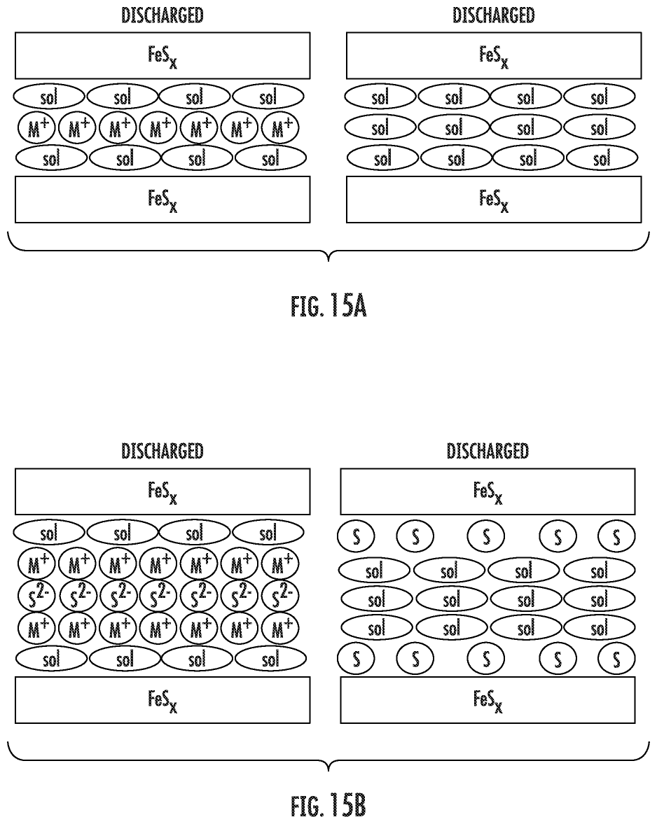

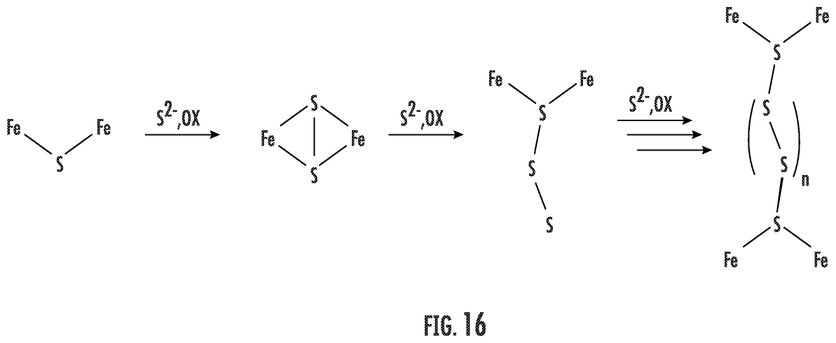

In some embodiments, an additional sulfur source is added. For instance, in some embodiments, the contacting is performed in the presence of a soluble sulfide source (i.e., a sulfide source that is soluble in the polar aprotic solvent). In some embodiments, the soluble sulfide source is an alkali metal sulfide, S₈, a thiourea, or 1,2,4,5-tetrazinane-3,6-dithione. The inclusion of additional sulfide can result in the net adjustment of the transition metal:S ratio. This can be used, for example, to alter the morphology of the layers of the transition metal sulfide. See FIG. 14. This can also be advantageous by providing additional negative charge to the layers, which can increase the charge storage density of the material (e.g., compared to a material without additional sulfide). For example, under charge/discharge cycles, it is possible that when an electrode prepared from the presently disclosed transition metal sulfide (e.g., FeS) and additional sulfide is fully discharged, free sulfide can be found in-between layers. Upon charging, however, these sulfide ions can be incorporated into the sheets. See FIGS. 15A and 15B. Further, possible formation of polysulfides between layers could limit the diffusion of polysulfides, which can otherwise prove problematic, and enhance the reversibility of sulfur batteries prepared from the presently disclosed subject matter. See FIG. 16.

In some embodiments, the presently disclosed subject matter provides a lamellar transition metal sulfide composition prepared by solvothermal decomposition of a transition metal complex in the presence of a salt.

In some embodiments, the presently disclosed subject matter provides a method of preparing a lamellar transition metal sulfide composition comprising layers of a transition metal sulfide (e.g., an amorphous transition metal sulfide) and further comprising cations (e.g., solvated cations) between layers of the transition metal sulfide, wherein the method comprises contacting a synthetic transition metal-sulfide cluster with an oxidizing agent in the presence of a polar aprotic solvent and a salt. In some embodiments, the salt is an alkali metal salt, an alkaline earth metal salt or an organic salt. In some embodiments, the transition metal sulfide cluster is a Fe₄S₄ cluster. In some embodiments, the transition metal sulfide cluster is [Fe₄S₄(SC₆H₅)₄](C₁₆H₃₆N)₂ (i.e., [Fe₄S₄(SPh)₄](TBA)₂). Suitable oxidizing agents include, but are not limited to, tetracyanoethylene (TCNE), iodine, ferrocenium tetrafluoroborate (FeCp₂BF₄), tetracyanoquinodimethane (TCNQ), and lithium chloroanilate (Li₂C₆Cl₂O₄).

As with the solvothermal decomposition method, in some embodiments, the alkali metal salt or the alkaline earth metal salt comprises a lithium, sodium, potassium, magnesium, or calcium salt. In some embodiments, the organic salt comprises a tetraalkylammonium salt (e.g., a TMA salt). Suitable anions for the salts include, but are not limited to triflate (OTf), a halide (e.g., chloride), and hexafluorophosphate. In some embodiments, the polar aprotic solvent is a carbonate, an ether, DMF, or acetonitrile. In some embodiments, the polar aprotic solvent is selected from DMF and THF. In some embodiments, the polar aprotic solvent is DMF. In some embodiments, the contacting is performed at a temperature between about 25° C. and about 140° C. As also noted above with regard to the compositions and solvothermal decomposition-based methods, interlayer spacing between consecutive layers of the transition metal sulfide can be dependent upon the identity of the cation and/or solvent present. Thus, in some embodiments, the interlayer spacing is tuned based on selection of a particular alkali metal salt, alkaline earth salt, or organic salt and/or based on the selection of a particular solvent.

In some embodiments, the presently disclosed subject matter provides a lamellar transition metal sulfide composition prepared by oxidizing a synthetic transition metal-sulfide cluster with an oxidizing agent in the presence of a polar aprotic solvent and a salt.

In some embodiments, the presently disclosed subject matter provides composites comprising the lamellar transition metal sulfide compositions of the presently disclosed subject matter. For example, the lamellar transition metal sulfides can be used to coat a conductive substrate, such as, a carbon-based substrate, such as a carbon fiber paper or carbon black. To facilitate the coating, the lamellar transition metal sulfide can be mixed with a polymeric binder (e.g., poly(vinylidene fluoride) (PVDF), natural rubber, or synthetic rubber). Thus, in some embodiments, the composite can comprise a conductive substrate coated with a mixture comprising a polymeric binder and a lamellar transition metal sulfide of the presently disclosed subject matter. The composites can be prepared, for instance, by dip-coating the substrate or painting the substrate with a slurry of the binder and the lamellar transition metal sulfide prepared in a polar aprotic solvent. In some embodiments, the resulting coating can comprise about 10% by weight of the binder.

In some embodiments, the presently disclosed subject matter provides an electrode comprising a lamellar transition metal sulfide composition of the presently disclosed subject matter. For example, in some embodiments, the electrode can comprise a composite of a presently disclosed lamellar transition metal sulfide as described hereinabove. In some embodiments, the presently disclosed subject matter provides a battery comprising an electrode comprising a lamellar transition metal sulfide composition of the presently disclosed subject matter or a composite thereof. The use of the material for battery electrodes allows it to be used to store electrical energy. Lithium- and sodium-ion battery materials with high capacity and stability have significant commercial potential, as lithium-ion batteries in particular are widely used in portable electronics, grid storage, and electric vehicles.

In some embodiments, the battery is a lithium-ion battery, a sodium-ion battery, or a magnesium-ion battery. In some embodiments, the battery is a lithium-ion battery having a discharge capacity of at least about 450 mAh/g for at least the first 17 cycles. In some embodiments, the battery exhibits cycling stability (e.g., of at least about 90%) for at least about 17 cycles when cycled between about 1.0 volts (V) and about 3.0 V. In some embodiments, the presently disclosed subject matter provides a metal-ion/sulfur battery comprising an electrode comprising a lamellar transition metal sulfide composition of the presently disclosed subject matter or a composite thereof. In some embodiments, the metal is lithium, sodium or magnesium.

The pseudocapacitance of electrodes made from the presently disclosed materials allow them to be used to store charge, for example, in a capacitor or supercapacitor device. The electrical conductivity of the material allows efficient charging/discharging of the electrode. Current and emerging applications for supercapacitors include computers, electric and fossil fuel vehicles, and storage of intermittent renewable energy. The simple synthesis of the material from low-cost materials could allow the presently disclosed materials to compete with existing supercapacitor technologies. Accordingly, in some embodiments, the presently disclosed subject matter provides a capacitor comprising an electrode comprising a lamellar transition metal sulfide composition of the presently disclosed subject matter or a composite thereof. In some embodiments, the electrode has a specific capacitance of about 100 F/g.

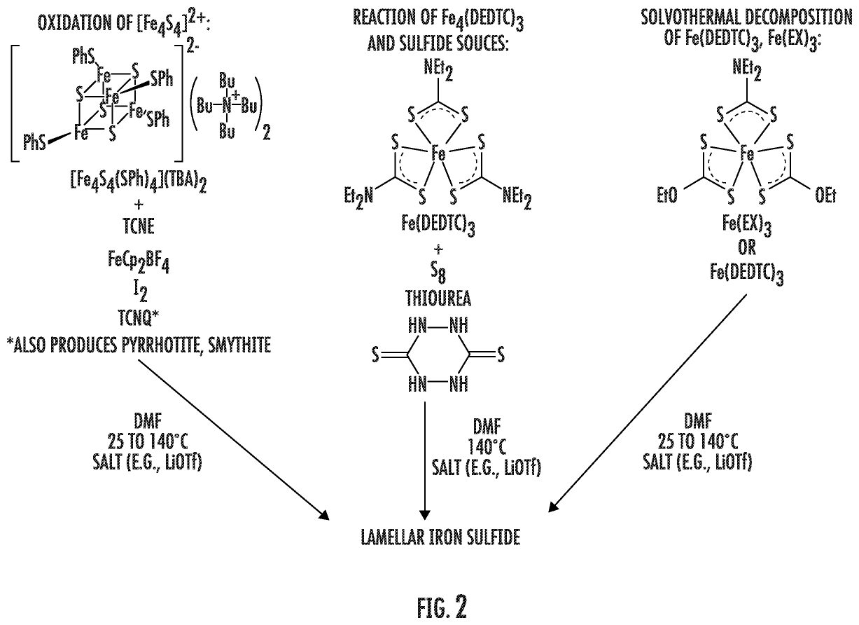

The presently disclosed lamellar transition metal sulfides are described further hereinbelow with regard to various exemplary iron sulfide embodiments. Approaches for the synthesis of the lamellar iron sulfides are shown in FIG. 2. For instance; synthesis of the material can be accomplished by solvothermal decomposition of a tris(dialkyldithiocarbamato)iron(III) or tris(alkylxanthato)iron(III) complex or by the reaction of a synthetic 4Fe-4S cluster (including [Fe₄S₄(SC₆H₅)₄](C₁₆H₃₆N)₂) with oxidizing agents (e.g., tetracyanoethylene (TCNE), iodine (I₂), ferrocenium tetrafluoroborate (FeCp₂BF₄), and lithium chloranilate). In both cases, the reactions are conducted in a polar aprotic solvent (dimethyl formamide or acetonitrile) under nitrogen atmosphere. A salt containing the desired cation can be added (including trifluoromethanesulfonate, chloride, and hexafluorophosphate salts of the aforementioned cations). Alternatively, the synthesis can be done by reaction of a tris(dialkyldithiocarbamato)iron(III) or tris(alkylxanthato)iron(III) complex and a sulfide source (e.g., S₈, thiourea, or 1,2,4,5-tetrazinane-3,6-dithione) in a polar aprotic solvent.

The material is obtained as a bulk powder or as a thin film on a substrate. The powder can be mixed with a polymeric binder and solvent to form a slurry and coated onto a conductive substrate (such as carbon fiber paper). Both the slurry- and thin film-coated substrates display pseudocapacitive electrochemical behavior over a potential window of about 1 V with specific capacitance of about 100 F/g (for material synthesized with Li). The bulk powder displays moderate electrical conductivity of about 0.5 S/cm at room temperature.

The exemplary lamellar iron sulfides comprise highly Earth-abundant elements (Fe and S) and can be prepared, as described above, from inexpensive commodity chemicals (e.g., potassium or sodium ethyl xanthate, iron (III) chloride, and a metal triflate salt). In contrast to previously reported iron sulfides, the lamellar structure of the material is expected to allow for easy/fast ion intercalation, which can increase the ability of the material to store charge in a capacitor. The specific capacitance of the material in preliminary measurements is comparable to other supercapacitor materials.

Pyrite has been tested extensively in lithium-ion batteries but suffers from degradation with cycling. The presently disclosed materials have a layered structure that can allow more reversible addition and removal of lithium ions, potentially improving stability on cycling. The initial capacity of the material is also higher than materials currently used in commercial lithium-ion batteries.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter.

### Example 1

### Synthesis, Structure, and Composition of Lamellar Iron Sulfides

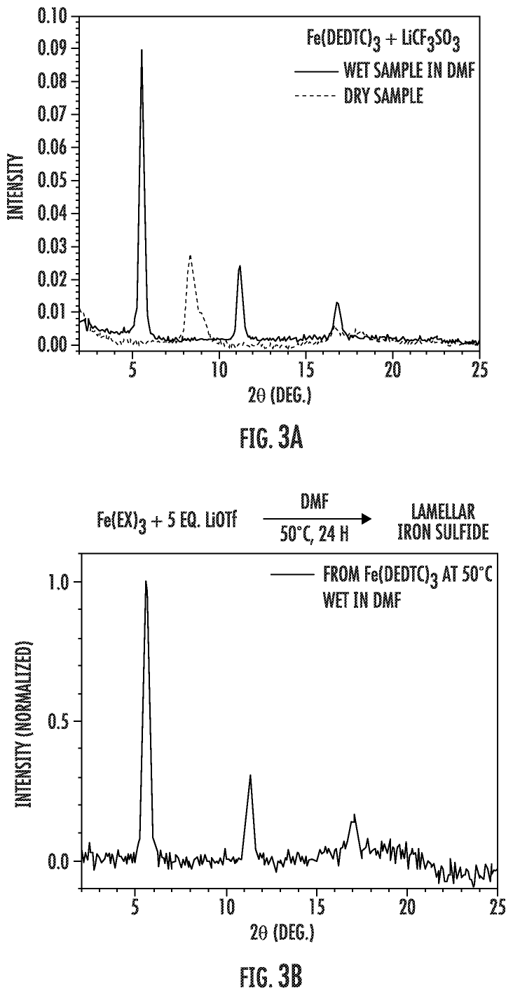

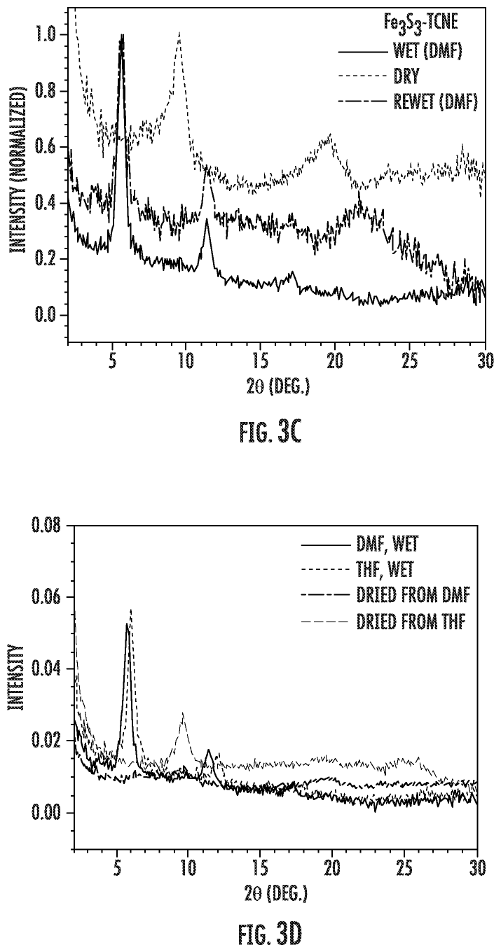

To synthesize the iron sulfides, precursor Fe(DEDTC)₃ was heated in dimethyl formamide with excess LiOTf (LiOTf=LiCF₃SO₃; DEDTC=diethyl dithio carbonate).¹⁴ X-ray powder diffraction (XRPD) analysis of the resulting deposit includes a specific peak position indicative of a lamellar structure. See FIG. 3A. Furthermore, drying of this material preserves the crystallinity, but results in a shifting of the peaks. This observation further supports the assignment of a lamellar structure and also suggests some degree of solvation between the layers. Multiple parallel composition analyses on this material suggest a formula of Fe_{0.75}SLi_{0.1} with the inclusion of solvent and possibly organic cations such as Me₂NH₂⁺.

Similarly, precursor Fe(EX)₃ was contacted with excess (e.g., 5 equivalents) LiOTf in DMF. At ambient temperature, the reaction was slow (72 h), but lead to uniform coatings due to a lack of thermal gradient. At 50° C., the reaction was faster (16 h) and led to a bulk powder. Compared to the reaction with Fe(EX)₃ as the precursor, solvothermal decomposition using Fe(DEDTC)₃ involved higher temperatures (e.g. 140° C.) and longer reaction times. In either case, the resulting material is air sensitive. XRPD analysis of the resulting wet material from solvothermal decomposition of Fe(EX)₃ is shown in FIG. 3B and is similar to that from the material prepared from Fe(DEDTC)₃.

Lamellar iron sulfide was also prepared from oxidation of Fe₄S₄(SPh)₄](TBA)₂ with TCNE in DMF. XRPD analysis of the resulting material is shown in FIG. 3C. Peaks move to higher angles upon drying and the material appears less ordered when dry. The changes in the XRPD spectrum are mostly reversible upon re-wetting of the material with DMF. See FIG. 3C. Small changes in the XRPD spectra were observed when the solvent for the synthesis was changed from DMF to THF. See FIG. 3D.

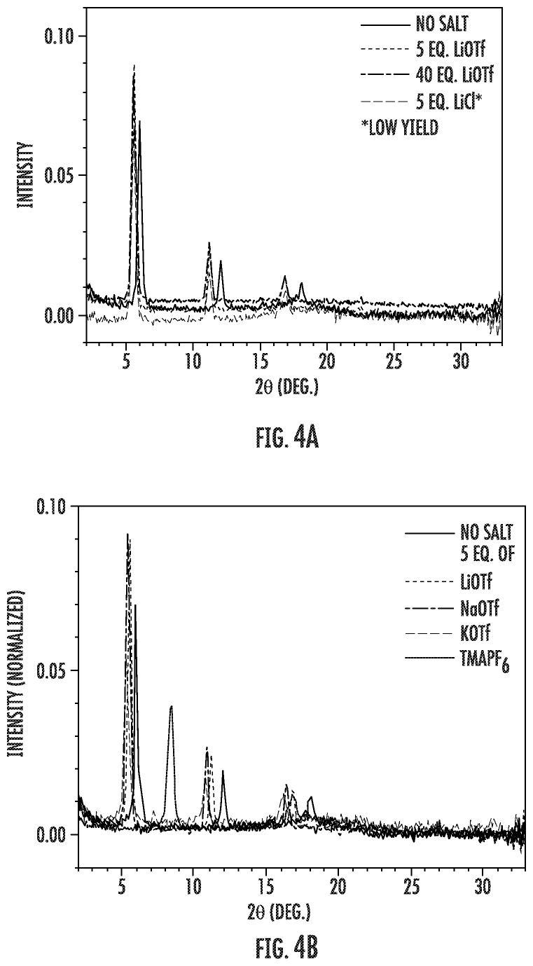

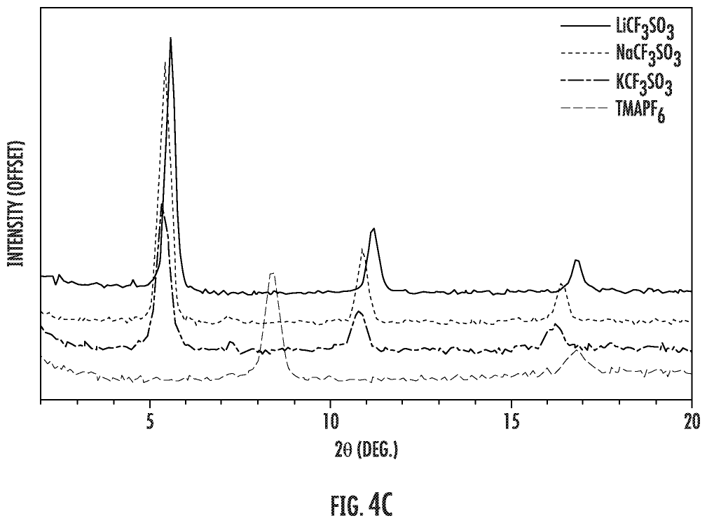

To investigate the effects of salt addition during synthesis, solvothermal decomposition was performed in the absence of added salt, with 5 equivalents of LiOTf (compared to the metal complex), 40 equivalents of LiOTf or with 5 equivalents of LiCl. It can be noted that the sample prepared without added salt can contain Me₂NH²⁺ from the DMF solvent used in the synthesis. Preparation in the presence of the LiCl salt showed low yield. However, the XRPD spectra of the samples prepared in the presence of both lithium salts were very similar. See FIG. 4A. Without being bound to any one theory, this result suggests the possibility that the anion is not present in the product.

The effect of changing the cation in the salt was also investigated. Lamellar iron sulfides were prepared in the presence of triflate salts of Li, Na, and K, as well as in the presence of a salt of an organic cation, tetramethylammonium (TMA⁺). XRPD spectra of the resulting lamellar iron sulfides are shown in FIGS. 4B and 4C. All of these materials show similar crystallinity and lamellar spacing by XRPD analysis. The spacing of the peaks in the XRPD spectra changes with the identity of the cation, which also supports assignment of a lamellar structure wherein the cations occupy the interlayer space. Furthermore, the TMA material shows the highest angle peaks which correspond to the smallest interlayer spacing. This is also consistent with the presence of solvated cations for the alkali metal variants, as TMA should not have any solvation sphere. While Li⁺ shows slightly smaller spacing than Na⁺ and K⁺, all of the alkali metal cations have very similar spacing which also suggests a relatively consistent solvation sphere in all three cases. It was further observed that with TMA⁺ as the cation, no change occurred upon drying, again suggesting that the TMA⁺ is not solvated.

In addition to monocations, the inclusion of dications, including Mg²⁺ and Ca²⁺, was investigated. Similar solids were obtained in these cases, although the materials were less crystalline. Lamellar peaks were still observed however, and the materials are still conductive. These observations support that a similar lamellar structure is being formed with dications.

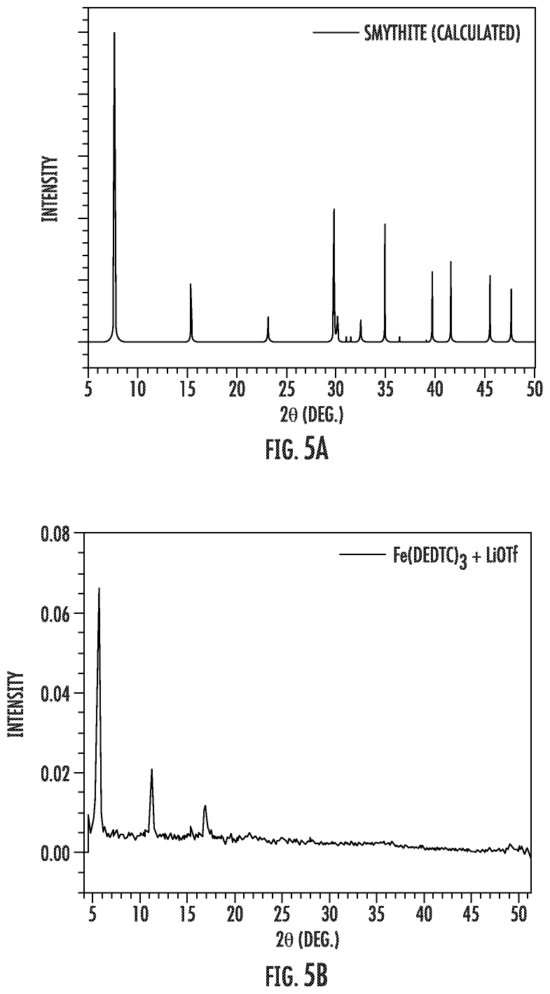

The present synthetic lamellar iron sulfides were next compared to a naturally occurring iron sulfide with ordered lamellar structure, i.e., Smythite. The calculated XRPD spectrum of Smythite is shown in FIG. 5A, while that of one of the presently disclosed synthetic iron sulfides is shown in FIG. 5B. No additional peaks were observed at higher angles in the synthetic iron sulfide, indicating that the lamellae are amorphous.

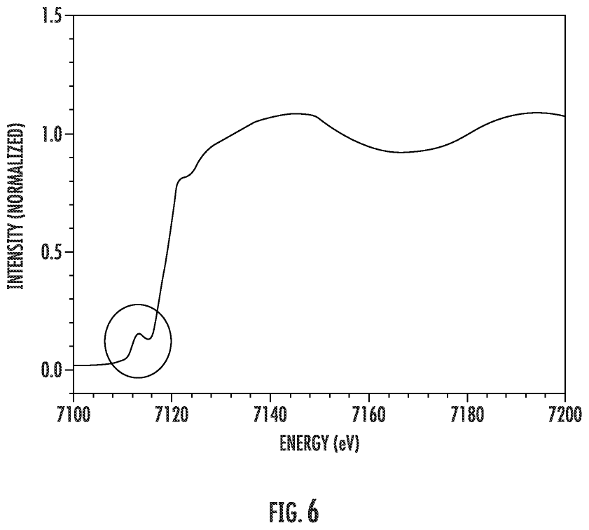

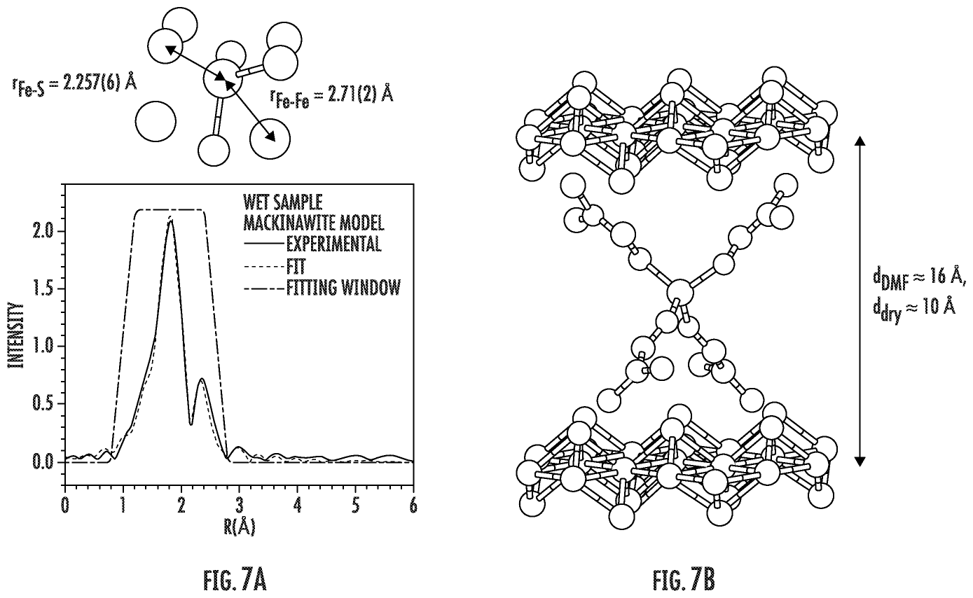

To further verify the structure of the material, X-ray absorption (XAS) measurements including extended X-ray absorbance fine structure analysis (EXAFS) was conducted. See FIGS. 6 and 7A. The edge position of the XAS spectrum is consistent with some Fe(II) or Fe(III) oxidation states and there are pre-edge features that are consistent with a lower symmetry (i.e. tetrahedral) coordination at Fe.¹⁶ See FIG. 6. This structural model is confirmed by fitting the EXAFS region of the spectrum which matches closely with a known layered mineral material Mackinawite, but which is a poor match with FeS₂ structures (e.g., Pyrite, Marcasite). See FIG. 7A. The spacing implied from the XRPD spectrum is consistent with the solvated cations implied from composition analysis, leading to a proposed structural model which consists of sheets of tetrahedral iron sulfide which are separated by solvated Li⁺. See FIG. 7B. Related low-valent iron sulfide minerals such as Mackinawite are known to be highly defective and amorphous and the lack of XRPD features at higher angles suggests similarly poor order within the sheets of the current material.¹⁵

In summary, the data suggests that the synthetic iron sulfides comprise poorly ordered FeS lamellae with mostly tetrahedral, but also octahedral coordination, with solvated ions (but probably just cations) between lamellae. For material synthesized with a lithium salt in DMF, the distance between lamellae in a wet state was about 16 Å, and about 10 Å after drying.

### Example 2

### Electronic Structure and Physical Properties of Lamellar Iron Sulfide

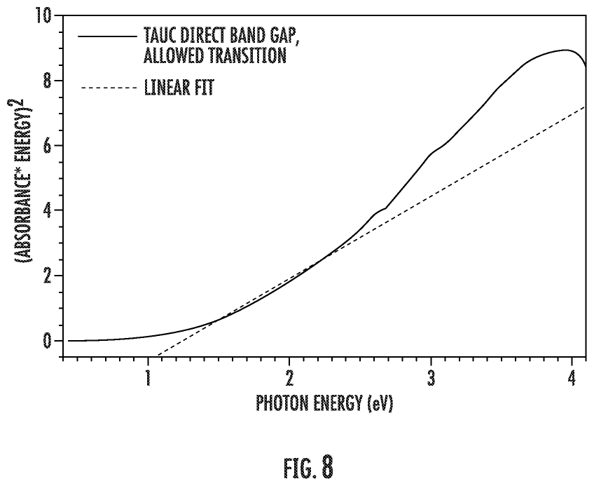

An initial electronic analysis was carried out on a synthetic lamellar iron sulfide material to determine its bulk conductivity. A crude pressed pellet conductivity of 0.4(2) S/cm was estimated, which suggests either a metallic or highly doped semi-conductor band structure. Initial experiments were performed to estimate the band gap of the material via a Tauc direct band gap from UV-visible absorption data. See FIG. 8. This initial analysis suggested a small bandgap of ˜1.2 eV.

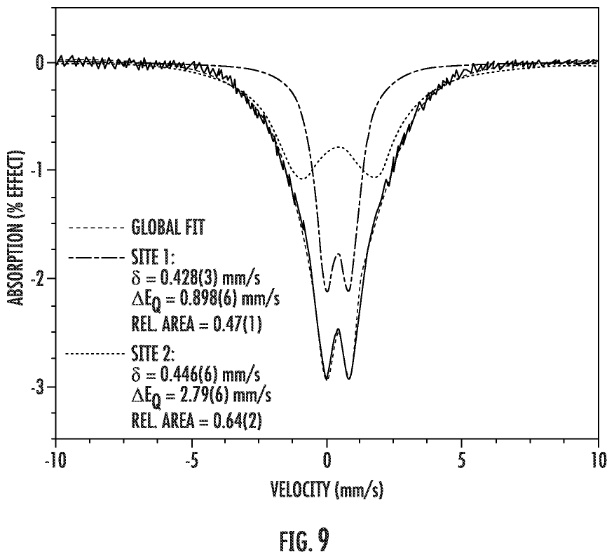

XAS analysis was performed to help determine the oxidation state(s) of the Fe centers in the lamellar material. While XAS analysis was generally consistent with an Fe(II) or Fe(III) oxidation state, the compositional analysis suggests the presence of Fe(III) states. Alternatively, there could also be incorporation of additional organic cations as mentioned. XAS only gives an average estimate of oxidation state, so Mössbauer spectroscopy was also performed to better understand the distribution of oxidation states in these materials. See FIG. 9. The Mössbauer spectrum shows two sites consistent with Fe(II) and Fe(III) centers, which supports the Fe:S ratio independently determined and confirms the presence of Fe(III) sites.

### Example 3

### Electrochemical Properties

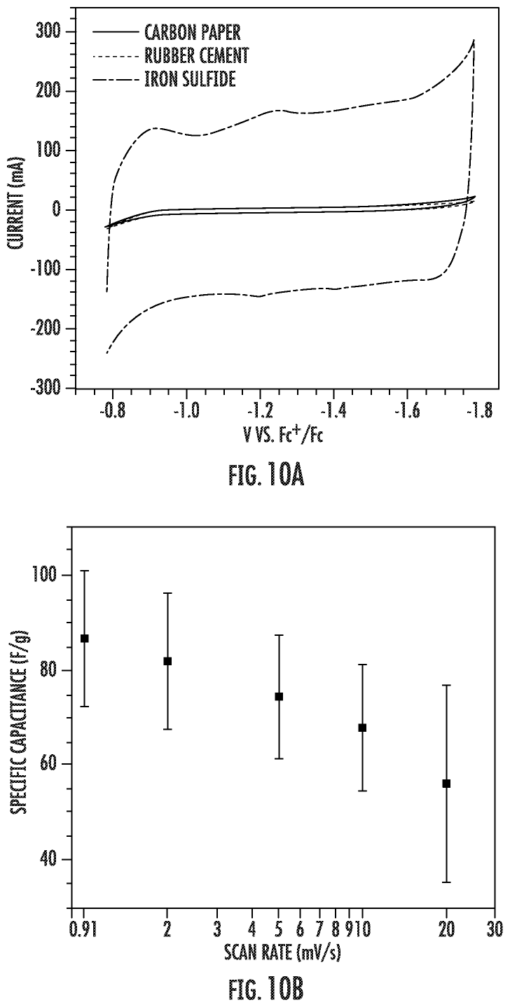

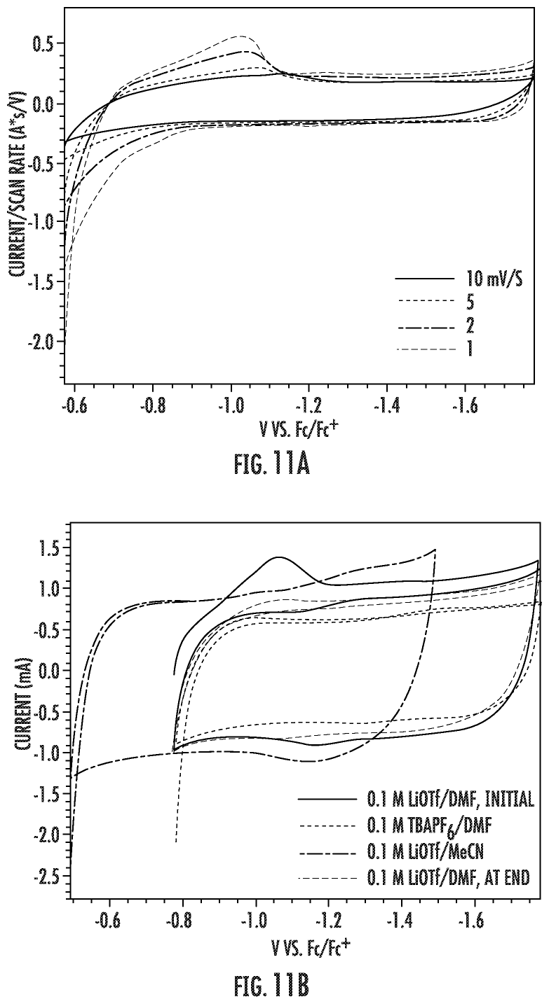

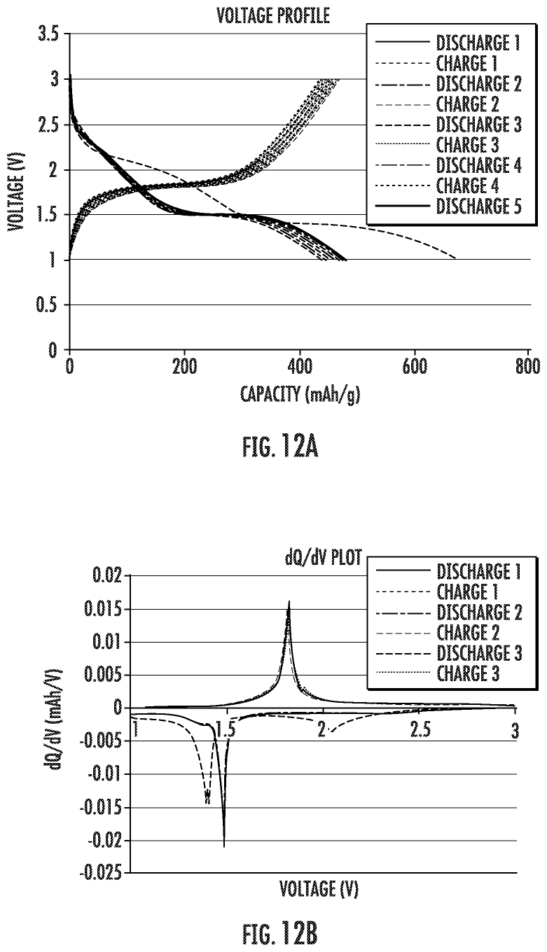

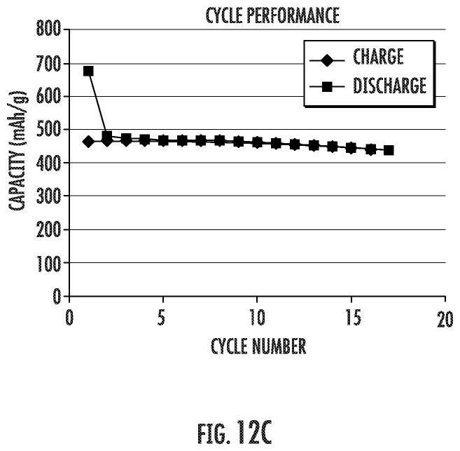

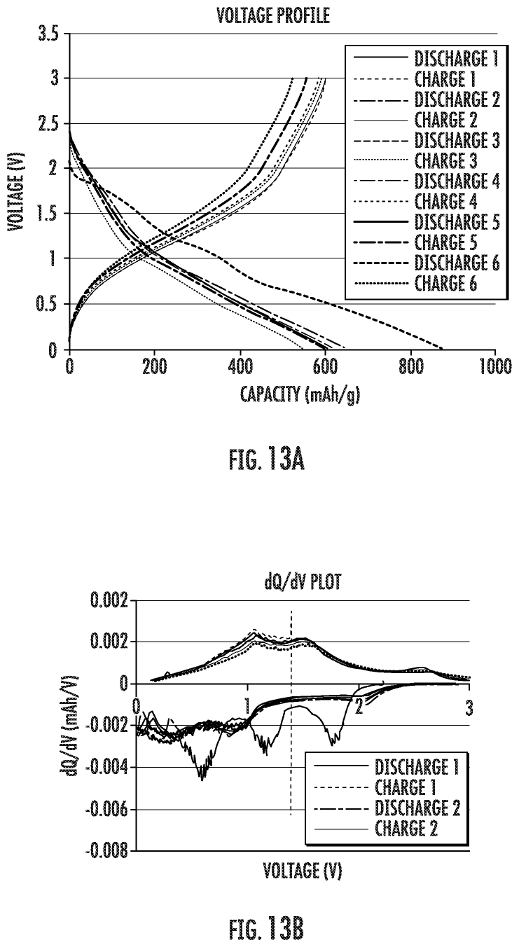

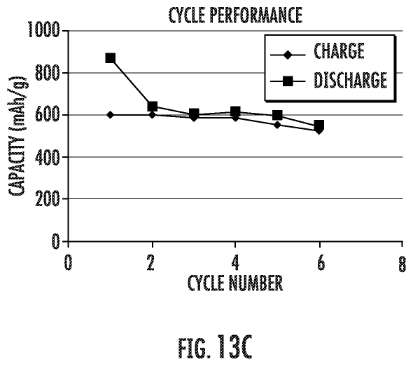

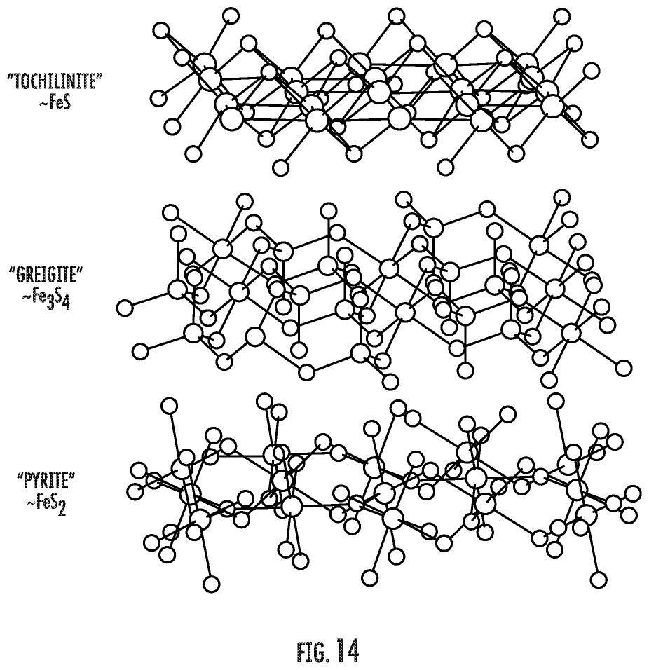

In addition to the characterization of the electronic structure of this material, its electrochemical properties were also characterized. The high conductivity and lamellar structure of this material make it a target for capacitor and battery applications. These properties were initially studied by cyclic voltammetry (CV). See FIGS. 10A, 10B, 11A, and 11B. A flat rectangular line shape was observed from ˜-0.8 V to −1.8 V indicating a primarily capacitive response across these potentials. A specific capacitance of nearly 100 F/g was observed, which is comparable to commercial supercapacitor materials, such as manganese oxides. There are additional Faradaic features outside of this window, which suggest that these materials should be competent for battery applications, as well. Results of preliminary half-cell tests of a lithium cell and a sodium cell prepared using the lamellar iron sulfides are shown in FIGS. 12A, 12B, 12C, 13A, 13B, and 13C. In particular, FIGS. 12A and 12C show that, in the lithium cell, the material has a capacity of 450-500 mAh/g. For reference, commercial cathode materials (e.g. in cell phones) are closer to 300 mAh/g, so it appears that the presently disclosed material performs significantly better. Furthermore, the cycling stability (see FIG. 12C) looks stable.

### REFERENCES

1. a) U.S. Department of Energy “Spotlight: Solving Challenges in Energy Storage” 2018 https://www.energy.gov/sites/prod/files/2018/09/f55/2018-08-23_Spotlight%20on%20Energy%20Storage%20%20Brochure%20and%20Success%20Stories_0.pdf. b) Kim, T.; Song, W. T.; Son, D. Y.; Ono, L. K.; Qi, Y. B. “Lithium-Ion Batteries: Outlook on Present, Future, and Hybridized Technologies” J. Mat. Chem. A 2019, 7, 2942-2964.
2. a) Dunn, B.; Kamath, H.; Tarascon, J. M. “Electrical Energy Storage for the Grid: A Battery of Choices” Science 2011, 334, 928-935. b) Cano, Z. P.; Banham, D.; Ye, S. Y.; Hintennach, A.; Lu, J.; Fowler, M.; Chen, Z. W “Batteries and Fuel Cells for Emerging Electric Vehicle Markets” Nature Energy 2018, 3, 279-289. c) Gur, T. M. “Review of Electrical Energy Storage Technologies, Materials and Systems: Challenges and Prospects for Large-Scale Grid Storage” Energy & Environmental Science 2018, 11, 2696-2767. d) Schmuch, R.; Wagner, R.; Horpel, G.; Placke, T.; Winter, M. “Performance and Cost of Materials for Lithium-Based Rechargeable Automotive Batteries” Nature Energy 2018, 3, 267-278. e) Cano, Z. P.; Banham, D.; Ye, S. Y.; Hintennach, A.; Lu, J.; Fowler, M.; Chen, Z. W “Batteries and Fuel Cells for Emerging Electric Vehicle Markets” Nature Energy 2018, 3, 279-289.
3. a) Schmuch, R.; Wagner, R.; Horpel, G.; Placke, T.; Winter, M. “Performance and Cost of Materials for Lithium-Based Rechargeable Automotive Batteries” Nature Energy 2018, 3, 267-278. b) Kennedy, D.; Philbin, S. P. “Techno-Economic Analysis of the Adoption of Electric Vehicles” Frontiers of Engineering Management 2019. c) Davies, D. M.; Verde, M. G.; Mnyshenko, O.; Chen, Y. R.; Rajeev, R.; Meng, Y. S.; Elliott, G. “Combined Economic and Technological Evaluation of Battery Energy Storage for Grid Applications” Nature Energy 2019, 4, 42-50.
4. a) Goodenough, J. B.; Park, K. S. “The Li-Ion Rechargeable Battery: A Perspective” J. Am. Chem. Soc. 2013, 135, 1167-1176. b) Li, M.; Lu, J.; Chen, Z.; Amine, K. “30 Years of Lithium-Ion Batteries” Adv. Mater. (Weinheim, Ger) 2018, 30, 1800561. c) Winter, M.; Barnett, B.; Xu, K. “Before Li Ion Batteries” Chem. Rev. 2018, 118, 11433-11456.
5. Kang, K. S.; Meng, Y. S.; Breger, J.; Grey, C. P.; Ceder, G. “Electrodes with High Power and High Capacity for Rechargeable Lithium Batteries” Science 2006, 311, 977-980.
6. a) Chan, C. K.; Peng, H. L.; Liu, G.; McIlwrath, K.; Zhang, X. F.; Huggins, R. A.; Cui, Y “High-Performance Lithium Battery Anodes Using Silicon Nanowires” Nat. Nanotechnol. 2008, 3, 31-35. b) Pumera, M. “Graphene-Based Nanomaterials for Energy Storage” Energy & Environmental Science 2011, 4, 668-674. c) Zhu, G. N.; Wang, Y. G.; Xia, Y. Y “Ti-Based Compounds as Anode Materials for Li-Ion Batteries” Energy & Environmental Science 2012, 5, 6652-6667. d) Zuo, X. X.; Zhu, J.; Muller-Buschbaum, P.; Cheng, Y. J. “Silicon Based Lithium-Ion Battery Anodes: A Chronicle Perspective Review” Nano Energy 2017, 31, 113-143.
7. a) Fergus, J. W “Recent Developments in Cathode Materials for Lithium Ion Batteries” J. Power Sources 2010, 195, 939-954. b) Nitta, N.; Wu, F. X.; Lee, J. T.; Yushin, G. “Li-Ion Battery Materials: Present and Future” Materials Today 2015, 18, 252-264. c) Li, W.; Song, B.; Manthiram, A. “High-Voltage Positive Electrode Materials for Lithium-Ion Batteries” Chem. Soc. Rev. 2017, 46, 3006-3059. d) Nayak, P. K.; Erickson, E. M.; Schipper, F.; Penki, T. R.; Munichandraiah, N.; Adelhelm, P.; Sclar, H.; Amalraj, F.; Markovsky, B.; Aurbach, D. “Review on Challenges and Recent Advances in the Electrochemical Performance of High Capacity Li- and Mn-Rich Cathode Materials for Li-Ion Batteries” Advanced Energy Materials 2018, 8. e) Liu, Q.; Su, X.; Lei, D.; Qin, Y.; Wen, J. G.; Guo, F. M.; Wu, Y. M. A.; Rong, Y. C.; Kou, R. H.; Xiao, X. H.; Aguesse, F.; Bareno, J.; Ren, Y.; Lu, W. Q.; Li, Y. X. “Approaching the Capacity Limit of Lithium Cobalt Oxide in Lithium Ion Batteries Via Lanthanum and Aluminium Doping” Nature Energy 2018, 3, 936-943. f) Qi, S.; Wu, D.; Dong, Y.; Liao, J.; Foster, C. W; O'Dwyer, C.; Feng, Y.; Liu, C.; Ma, J. “Cobalt-Based Electrode Materials for Sodium-Ion Batteries” Chem. Eng. J. (Lausanne) 2019, 370, 185-207.
8. a) Chung, S. Y.; Bloking, J. T.; Chiang, Y. M. “Electronically Conductive Phospho-Olivines as Lithium Storage Electrodes” Nat. Mater. 2002, 1, 123-128. b) Ellis, B. L.; Makahnouk, W. R. M.; Makimura, Y.; Toghill, K.; Nazar, L. F. “A Multifunctional 3.5 V Iron-Based Phosphate Cathode for Rechargeable Batteries” Nat. Mater. 2007, 6, 749-753. c) Yuan, L. X.; Wang, Z. H.; Zhang, W. X.; Hu, X. L.; Chen, J. T.; Huang, Y. H.; Goodenough, J. B. “Development and Challenges of LiFePO₄ Cathode Material for Lithium-Ion Batteries” Energy & Environmental Science 2011, 4, 269-284.
9. Patry, G.; Romagny, A.; Martinet, S.; Froelich, D. “Cost Modeling of Lithium-Ion Battery Cells for Automotive Applications” Energy Science & Engineering 2015, 3, 71-82.
10. a) Fong, R.; Jones, C. H. W; Dahn, J. R. “A Study of Pyrite-Based Cathodes for Ambient-Temperature Lithium Batteries by Insitu Fe-57 Mossbauer-Spectroscopy” J. Power Sources 1989, 26, 333-339. b) Fong, R.; Dahn, J. R.; Jones, C. H. W “Electrochemistry of Pyrite-Based Cathodes for Ambient-Temperature Lithium Batteries” J. Electrochem. Soc. 1989, 136, 3206-3210. c) Tryk, D. A.; Kim, S. H.; Hu, Y. N.; Xing, W. N.; Scherson, D. A.; Antonio, M. R.; Leger, V. Z.; Blomgren, G. E. “Electrochemical Insertion of Lithium into Pyrite from Nonaqueous Electrolytes at Room-Temperature—an in-Situ Fe K-Edge X-Ray-Absorption Fine-Structure Study” J. Phys. Chem. 1995, 99, 3732-3735.
11. a) Liu, J.; Wen, Y. R.; Wang, Y.; van Aken, P. A.; Maier, J.; Yu, Y “Carbon-Encapsulated Pyrite as Stable and Earth-Abundant High Energy Cathode Material for Rechargeable Lithium Batteries” Adv. Mater. (Weinheim, Ger) 2014, 26, 6025. b) Hu, Z.; Zhu, Z. Q.; Cheng, F. Y.; Zhang, K.; Wang, J. B.; Chen, C. C.; Chen, J. “Pyrite FeS₂ for High-Rate and Long-Life Rechargeable Sodium Batteries” Energy & Environmental Science 2015, 8, 1309-1316. c) Douglas, A.; Carter, R.; Oakes, L.; Share, K.; Cohn, A. P.; Pint, C. L. “Ultrafine Iron Pyrite (FeS₂) Nanocrystals Improve Sodium-Sulfur and Lithium-Sulfur Conversion Reactions for Efficient Batteries” ACS Nano 2015, 9, 11156-11165. d) Walter, M.; Zund, T.; Kovalenko, M. V. “Pyrite (FeS₂) Nanocrystals as Inexpensive High-Performance Lithium-Ion Cathode and Sodium-Ion Anode Materials” Nanoscale 2015, 7, 9158-9163. e) Zhu, Y. J.; Fan, X. L.; Suo, L. M.; Luo, C.; Gao, T.; Wang, C. S. “Electrospun FeS₂@Carbon Fiber Electrode as a High Energy Density Cathode for Rechargeable Lithium Batteries” ACS Nano 2016, 10, 1529-1538. f) Liu, Z. M.; Lu, T. C.; Song, T.; Yu, X. Y.; Lou, X. W.; Paik, U. “Structure-Designed Synthesis of FeS₂@C Yolk-Shell Nanoboxes as a High-Performance Anode for Sodium-Ion Batteries” Energy & Environmental Science 2017, 10, 1576-1580.
12. a) Dugast, A.; Brec, R.; Ouvrard, G.; Rouxel, J. “Li₂FeS₂, a Cathodic Material for Lithium Secondary Battery” Solid State Ionics 1981, 5, 375-378. b) Brec, R.; Prouzet, E.; Ouvrard, G. “Redox Processes in the LiₓFeS₂/Li Electrochemical System Studied through Crystal, Mössbauer, and EXAFS Analyses” J. Power Sources 1989, 26, 325-332.
13. a) Guo, J.; Lei, H.; Hayashi, F.; Hosono, H. “Superconductivity and Phase Instability of Nh3-Free Na-Intercalated FeSe_{1-Z}S_{z}” Nature Comm. 2014, 5, 4756. b) Wu, D.; Guo, Z.; Liu, N.; Zhou, L.; Mao, Y.; Wan, L.; Sun, F.; Yuan, W. “A New Intercalated Iron Sulfide (C₂H₈N₂)_{0.4}Fe₂S₂ from Solvothermal Route: Synthesis, Structure and Tunable Magnetism” Inorg. Chem. Commun. 2018, 91, 72-76.
14. Leipoldt, J. G.; Coppens, P. “Correlation between Structure- and Temperature-Dependent Magnetic Behavior of Iron Dithiocarbamate Complexes. Crystal Structure of Tris(N,N Diethyldithiocarbamato)Iron(III) at 297 And 79 K” Inorg. Chem. 1973, 12, 2269-2274.
15. a) Ohfuji, H.; Rickard, D. “High Resolution Transmission Electron Microscopic Study of Synthetic Nanocrystalline Mackinawite” Earth Planet. Sci. Lett. 2006, 241, 227-233. b) Bourdoiseau, J.-A.; Jeannin, M.; Sabot, R.; Rémazeilles, C.; Refait, P. “Characterisation of Mackinawite by Raman Spectroscopy: Effects of Crystallization, Drying and Oxidation” Corros. Sci. 2008, 50, 3247-3255.
16. He et al., Geochim. Cosmochim. Acta 2010, 74(7), 2025-2039.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A lamellar transition metal sulfide composition comprising layers of an amorphous transition metal sulfide and further comprising cations between layers of the amorphous transition metal sulfide.

2. The lamellar transition metal sulfide composition of claim 1, wherein the cation is a solvated cation.

3. The lamellar transition metal sulfide composition of claim 1 or claim 2, wherein the transition metal sulfide comprises one or more transition metal selected from the group consisting of scandium (Sc), titanium (Ti), vanadium (V), chromium (Cr), manganese (Mn), iron (Fe), cobalt (Co), nickel (Ni), copper (Cu), and zinc (Zn).

4. The lamellar transition metal sulfide composition of any one of claims 1-3, wherein the transition metal sulfide is an iron sulfide.

5. The lamellar transition metal sulfide composition of claim 4, wherein the ratio of iron (Fe) to sulfur (S) in the iron sulfide is about 0.75 to 1.

6. The lamellar transition metal sulfide composition of any one of claims 1-5, wherein the cations comprise monocations, dications, or combinations thereof.

7. The lamellar transition metal sulfide composition of claim 6, wherein the cations are alkali metal cations, alkaline earth metal cations, or organic cations.

8. The lamellar transition metal sulfide composition of claim 6 or claim 7, wherein the cations comprise one or more cations selected from Li⁺, Na⁺, K⁺, Mg²⁺, Ca²⁺, and tetraalkylammonium cations.

9. The lamellar transition metal sulfide composition of any one of claims 1-8, wherein the cations are solvated by a polar aprotic solvent.

10. The lamellar transition metal sulfide composition of claim 9, wherein the polar aprotic solvent comprises a carbonate solvent, an ether solvent, dimethyl formamide (DMF), or acetonitrile.

11. The lamellar transition metal sulfide composition of any one of claims 1-10, wherein the cation and/or a solvent for solvation of the cation is selected to obtain a desired interlayer spacing between consecutive layers.

12. A method of preparing a lamellar transition metal sulfide composition comprising layers of an amorphous transition metal sulfide and further comprising cations between layers of the amorphous transition metal sulfide, wherein the method comprises contacting a transition metal complex selected from the group consisting of a bis- or tris(dialkyldithiocarbamato)transition metal complex and a bis- or tris(alkylxanthato)transition metal complex with a polar aprotic solvent for a period of time in the presence of an alkali metal salt, an alkaline earth metal salt, or an organic salt.

13. The method of claim 12, wherein the cations between layers of the amorphous transition metal sulfide are solvated cations.

14. The method of claim 12 or claim 13, wherein the contacting is performed at a temperature of at least about 25° C.

15. The method of claim 14, wherein the contacting is performed at a temperature of between about 25° C. and about 140° C.

16. The method of any one of claims 12-15, wherein the transition metal complex is selected from tris(diethyldithiocarbamato)iron(III) (Fe(DEDTC)₃) and tris(ethylxanthato)iron(III) (Fe(EX)₃).

17. The method of any one of claims 12-16, wherein the alkali metal salt, the alkaline earth metal salt, or the organic salt comprises a lithium, sodium, potassium, magnesium, calcium, or tetraalkylammonium salt and/or wherein the salt comprises an anion selected from a triflate, a chloride, and a hexafluorophosphate.

18. The method of any one of claims 12-17, wherein the polar aprotic solvent comprises a carbonate, an ether, DMF, or acetonitrile.

19. The method of claim 18, wherein the polar aprotic solvent is selected from the group consisting of DMF and tetrahydrofuran (THF).

20. The method of any one of claims 12-19, wherein the contacting is performed in the presence of a soluble sulfide source.

21. The method of claim 20, wherein the soluble sulfide source comprises an alkali metal sulfide, S₈, a thiourea, or 1,2,4,5-tetrazinane-3,6-dithione.

22. The method of any one of claims 12-21, wherein interlayer spacing between consecutive layers is tuned based on selection of the salt and/or solvent.

23. The lamellar transition metal sulfide composition prepared according to the method of any one of claims 12-22.

24. A method of preparing a lamellar transition metal sulfide composition comprising layers of an amorphous transition metal sulfide and further comprising cations between layers of the amorphous transition metal sulfide, wherein the method comprises contacting a synthetic transition metal-sulfide cluster with an oxidizing agent in the presence of a polar aprotic solvent and an alkali metal salt, an alkaline earth metal salt, or an organic salt.

25. The method of claim 24, wherein the cations between layers of the amorphous transition metal sulfide are solvated cations.

26. The method of claim 24 or claim 25, wherein the synthetic transition metal-sulfide cluster is a 4Fe-4S cluster.

27. The method of claim 26, wherein the 4Fe-4S cluster is [Fe₄S₄(SC₆H₅)₄](C₁₆H₃₆N)₂.

28. The method of any one of claims 24-27, wherein the oxidizing agent is selected from the group consisting of tetracyanoethylene (TCNE), iodine, ferrocenium tetrafluoroborate (FeCp₂BF₄), tetracyanoquinodimethane (TCNQ), and lithium chloroanilate (Li₂C₆Cl₂O₄).

29. The method of any one of claims 24-28, wherein the polar aprotic solvent is DMF and/or the contacting is performed at a temperature between about 25° C. and about 140° C.

30. The method of any one of claims 24-29, wherein interlayer spacing between consecutive layers is tuned based on selection of the salt and/or solvent.

31. The lamellar transition metal sulfide composition prepared according to the method of any one of claims 24-30.

32. A composite comprising (i) a conductive substrate and (ii) a polymeric binder combined with a lamellar transition metal sulfide composition of any one of claims 1-11, 23, and 31.

33. The composite of claim 32, wherein the conductive substrate is carbon fiber paper or carbon black.

34. The composite of claim 32 or 33, wherein the polymeric binder is poly(vinylidene fluoride) (PVDF), natural rubber, or synthetic rubber.

35. An electrode comprising a lamellar transition metal sulfide composition of any one of claims 1-11, 23, and 31 or a composite of any one of claims 32-34.

36. A metal-ion battery comprising an electrode of claim 35.

37. The metal-ion battery of claim 36, wherein the battery is a lithium-, sodium-, or magnesium-ion battery.

38. The metal-ion battery of claim 36 or 37, wherein said battery is a lithium-ion battery and the electrode has a discharge capacity of at least about 450 mAh/g or more for at least a first 17 cycles.

39. The metal-ion battery of any one of claims 36-38, wherein said electrode exhibits a cycling stability of at least 90% for at least 17 cycles when cycled between 1.0 volts (V) and 3.0 V.

40. A capacitor comprising an electrode of claim 35.

41. The capacitor of claim 40, wherein the electrode has a specific capacitance of about 100 F/g.

42. A metal-ion/sulfur battery comprising an electrode of claim 35.

43. The metal-ion/sulfur battery of claim 42, wherein the metal is lithium, sodium, or magnesium.
